(19) United States
(12) Patent Application Publication
(10) Pub. No.: US 2005/0245282 A1
(43) Pub. Date: Nov. 3, 2005

(54) Battery with ignitor device configured for powering a mobile telecommunications device

(75) Inventor: Jeff Brudos, American Fork, UT (US)

Correspondence Address: MORRISS O'BRYANT COMPAGNI, P.C., 136 SOUTH MAIN STREET, SUITE 700, SALT LAKE CITY, UT, 84101, US

(73) Assignee: Rand Holdings, LLC

(21) Appl. No.: 11/108,218

(22) Filed: Apr. 18, 2005

Related U.S. Application Data
(63) Continuation-in-part of application No. 10/883,571, filed on Jul. 1, 2004.
(60) Provisional application No. 60/484,187, filed on Jul. 1, 2003.

(51) Int. Cl. H04B 7/00

(52) U.S. Cl. 455/550.1

(57) ABSTRACT

A battery configured for powering a mobile communications device is disclosed. The battery includes an integrally associated ignitor device for ignition of flammable elements, such as cigarettes, cigars, pipes, incense and the like. The battery and ignitor device alone or in combination with a mobile communications device facilitate combustion of any flammable object including smokable items and emergency flammable items, such as flares or kindling.

### CROSS-REFERENCE TO RELATED APPLICATION

This is a continuation-in-part application of non-provisional application Ser. No. 10/883,571, filed, Jul. 1, 2004, titled MOBILE TELECOMMUNICATIONS DEVICE WITH CIGARETTE LIGHTER, pending, which in turn claims priority to provisional application Ser. No. 60/484,187, filed, Jul. 1, 2003, titled MOBILE TELECOMMUNICATIONS DEVICE/CIGARETTE LIGHTER.

### BACKGROUND OF THE INVENTION

1. Field of the Invention

This invention relates to batteries for mobile communications devices, such as mobile telephones or personal digital assistants (PDAs) and specifically relates to the combination of a battery for a mobile communications device with a cigarette lighter device to facilitate ready location of an ignition device for igniting a smokable or flammable item.

2. Description of Related Art

In the current age, mobile communications devices, particularly mobile telephones, are ubiquitous. In many parts of the world, many people are seldom without them, carrying them on their belts, in their purses, pockets, automobiles, or any other number of readily handy places. Because they are constantly in communication with others, either for business or personal reasons, people tend to be cognizant of their mobile telephones and tend to always know where they are and keep them available.

In contrast, people who smoke constantly misplace their cigarette lighters or other devices they use for lighting their cigarettes. As a result, smokers are constantly searching for a “light.” At the same time, however, smokers presumably use mobile telephones or other communications devices with the same frequency as non-smokers, or as the population at large. Thus, many smokers will generally be able to locate their mobile telephones even when they cannot find their lighters or other igniting device.

As a consequence, it would be an improvement on the existing technology to combine a cigarette lighter with a mobile communications device to create one unit that serves multiple functions. This would allow smokers who carry mobile telephones or other communications devices to always be in possession of a means to light their cigarettes. Even if a smoker was not in possession of a mobile communications device with a cigarette lighter function, he or she could probably obtain a “light” from another person having a mobile communications device with such a function.

A mobile communications device with a cigarette lighter function provides a benefit not only to smokers, but also to hikers and other individuals who may find themselves lost or stranded in a cold or otherwise hostile environment and in need of a source of flame to build a fire. Once again, people are frequently caught in such situations without matches or other fire-starting materials, but would more likely have their mobile phones. While having a mobile phone in such dire circumstances would usually allow a stranded person to call for help, the ready availability of an ignition device would allow the person to build a fire until help arrived. Furthermore, hikers, and even motorists, can frequently find themselves lost or stranded in an area that lacks communications frequency transmission, and having access to a lighter may provide the very chance for survival. Pending non-provisional application Ser. No. 10/883,571, filed, Jul. 1, 2004, titled MOBILE TELECOMMUNICATIONS DEVICE WITH CIGARETTE LIGHTER to Jeff Brudos discloses one approach solving this problem and is incorporated herein by reference for all purposes.

Virtually all mobile telecommunications devices are powered by batteries that are either integral to the device or removable and are generally rechargeable. Such batteries may be nickel-cadmium, lithium ion, lithium polymer or any other rechargeable battery technology suitable for powering a mobile telecommunications device. Electrical and mechanical interfaces, features and chemical technology for stand-alone mobile telecommunications device batteries are well known in the art. However, the inventor is not aware of any such batteries that are integrated with, or attachable to, a lighter.

Features and methods of manufacturing standalone fuel-based lighters using flammable fluids or flammable compressed gases are well known in the art. However, the inventor is not aware of any such fuel-based lighter that has been integrated with a battery for powering a mobile communications device. Features and methods of manufacturing a standalone electrically-based lighter are known in the art. For example, see U.S. Pat. No. 4,089,636 to Goto, U.S. Pat. Nos. 5,235,157, 5,274,214 and 5,285,050 all to Blackburn and U.S. Pat. No. 5,354,968 to Yamamura. However, none of these patents discloses or suggests integrating such an electrically-based lighter with a battery configured for powering a mobile telecommunications device.

Thus, it would be an advantage in the art, for the reasons stated previously, to provide a battery configured for powering a mobile communications device having an integrally formed or attached ignition device for producing a heat source that may be used to ignite flammable items, such as cigarettes or kindling.

### BRIEF SUMMARY OF THE INVENTION

In accordance with the present invention, a battery configured for powering a mobile communications device is structured with an ignition device for providing a heat source to ignite a flammable element. The invention is described herein with respect to a mobile telephone; however, other forms of mobile communications devices, such as a PDA, wireless, handheld, or tablet, personal computer (PC) and telephonic communications devices, such as a Blackberry®, may be combined with a battery configured for powering such handheld communications devices including an ignition device in accordance with the present invention.

The present invention generally comprises a battery configured for powering a mobile (e.g., wireless) communications device structurally combined with an ignition mechanism providing a heat source sufficient to ignite a flammable element. The mobile communications device to which the battery and ignition device of the present invention may be attached may include a housing which contains suitable electronic hardware and software for providing desired modes of communication. In conjunction therewith, the housing is structured to provide or contain those structural members that enable use of the communications device, including typically a display screen, keypad, keyboard, function buttons, receiver, voice amplifier, microphone and combinations of such items. The communications device may also include hardware and software for providing numerous other user capabilities, such as capturing and sending photographic images via wireless communication and accessing commercial radio waves.

The battery of the present invention may include a housing providing structure for associating an ignition device in addition to the power source function suitable for powering a mobile telecommunications device. An embodiment of the ignition device may be positioned, at least in part, within the housing of the battery. In an alternative embodiment, the ignition device may be integrally supported by the housing such that, for example, the ignition device is detachably attached to the housing of the battery.

The ignition device, in accordance with the present invention, may be structured in any suitable manner to provide a source of heat sufficient to ignite a flammable element. For example, the ignition device may comprise a flame that is fueled by an appropriate compressed gas in a fashion much like a conventional butane lighter. Accordingly, the ignition device may comprise a fuel reservoir that is positioned within the housing of the battery. The fuel reservoir may include a wick or other means for delivering fuel to the point of ignition. A gas-igniting member is positioned to ignite the gas to produce a flame. The gas-igniting member may be a friction mechanism, such a conventional rotatable wheel that contacts a flint. Alternatively, the gas-igniting member may be a piezoelectrical sparking device of conventional and known structure. Any other suitable gas-igniting member may also be employed consistent with embodiments of the present invention.

For embodiments where a fuel reservoir is used, the reservoir may be permanently built into the battery housing and is refillable through a valved opening in the housing, as is known in conventional refillable butane lighters. Alternatively, the fuel reservoir and associated gas-igniting assembly may be removable and replaceable. Embodiments of a fuel reservoir may be formed of a translucent or see-through material to facilitate visual inspection of remaining fuel in the reservoir according to the present invention. In either case, it is preferred that the fuel reservoir be resistant to breakage and leak resistant. Other conventional features may be associated with the gas-fueled structure of the ignition device, such as a selectively adjustable regulator valve that enables the user to regulate fuel flow and, thus, regulate the magnitude of the flame.

Alternatively to a gas-fueled structure, the ignition device of the invention may comprise an electrical heating element, similar to those conventionally known and installed in vehicles. The alternative ignition device may include a heating element sized to fit conveniently within the battery housing. The heating element may be enabled in any suitable manner by the user to cause the heating element to become hot, thereby providing a heat source for igniting a flammable element. Any number of means may be employed to initiate heating of the element, including by way of example only, a depressible starter button positioned on the housing, which closes an electrical circuit to initiate heating of the element, or a software-programmed or voice command that initiates the mechanical closing of an electrical circuit to initiate heating of the element. It is further within the scope of the invention that the heating element of the device may be detachable from the communications device to provide ignition remotely from the communications device. Alternatively, the heating element may be affixed to the housing and, thus, not detachable according to another embodiment of the present invention.

Regardless of the type of igniting device that is employed, the housing may be structured with a heat shield plate positioned about the heat source to protect the battery housing, battery and any electronic systems within the housing from overheating and becoming damaged. Further, the present invention is preferably structured with safety mechanisms that either prevent access to the heat source and/or selectively disable the heat source during times of unintended use. As used herein “unintended use” means operation of the ignitor device by unauthorized persons, such as young children and during periods of time when an authorized person does not wish to use the ignitor device. It is not meant to imply that the ignitor device is otherwise not usable concurrently as a battery for powering and using a mobile communications device to which it is attached. The safety mechanism may include a movable cover that is openable to expose the heat source of the ignition device and is then closable to enclose the heat source of the ignition device while not in use.

The invention may also be structured with a locking mechanism that, for example, prevents the cover from opening while not in use and which prevents children from opening the cover to tamper with the ignition device. Any suitable means, both mechanical and/or electrical (including using programmable software commands), may be used to provide the safety mechanism or locking mechanism according to embodiments of the present invention.

Embodiments of a battery and ignitor device are also disclosed. The device may include a battery configured for powering a mobile communications device capable of contacting other persons or communications devices by wireless connections systems. The device may further include a housing enclosing the battery and an ignitor device configured for attachment to the housing for providing a heat source for ignition of flammable elements.

These and additional features of the battery configured for powering a mobile communications and ignition device of the present invention are better understood with reference to the drawings and detailed description that follow.

### BRIEF DESCRIPTION OF THE SEVERAL VIEWS OF THE DRAWINGS

The following drawings illustrate exemplary embodiments for carrying out the invention. Like reference numerals refer to like parts in different views or embodiments of the present invention in the drawings.

FIG. 1 is a perspective view of a first embodiment of the present invention, structured with a fueled ignition device.

FIG. 2 is a side view of the embodiment of the invention shown in FIG. 1, taken at line 2-2.

FIG. 3 is a view in longitudinal cross section taken at line 3-3 of FIG. 1.

FIG. 4 is a view in longitudinal cross section of a second embodiment of the invention.

FIG. 5 is a view in longitudinal cross section of a third alternative embodiment of the invention.

FIG. 6 is a perspective view of yet a fourth alternative embodiment of the present invention.

FIG. 7 is a view in longitudinal cross section of the embodiment of the invention shown in FIG. 6, taken at line 7-7.

FIG. 8 is a perspective view of a fifth alternative embodiment of the present invention.

FIG. 9 is block diagram of an embodiment of a battery and ignitor device according to the present invention.

FIG. 10 is block diagram of an alternative embodiment of a battery and ignitor device according to the present invention.

### DETAILED DESCRIPTION OF THE INVENTION

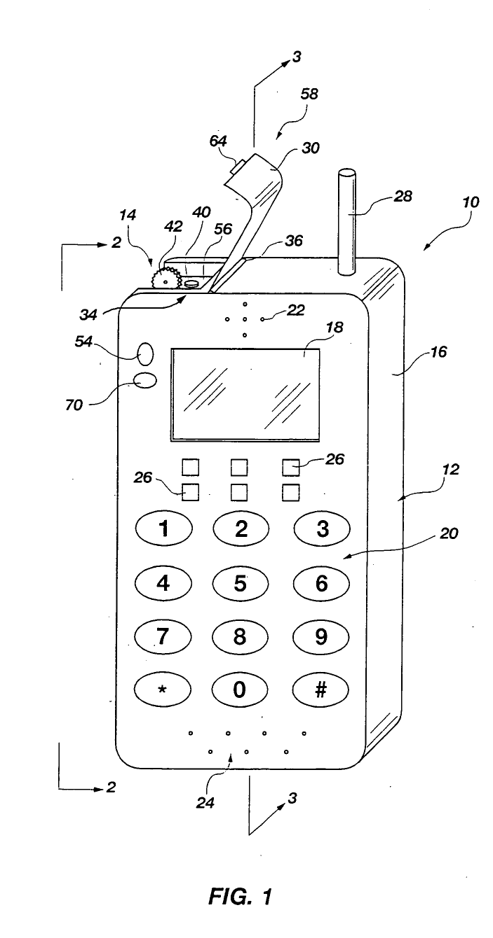

FIG. 1 depicts the principal elements of the mobile communications-ignition device 10 of the present invention, which includes a communications device 12, here depicted as a mobile or wireless telephone, and an ignition device 14. The invention 10 includes a housing 16 which encloses the conventional hardware, software and electronics of the communications device 12. The housing also provides a full or partial enclosure for the ignition elements of the ignition device 14.

The housing 16 may provide for the conventional structures of the communications device 12, here including a display screen 18, a keypad 20, a receiver 22 for hearing transmitted telephone signals, a microphone 24 for sending voice signals, various ancillary function keys 26 and an optional extending and/or extendable antenna 28. The structural elements shown do not constitute an exhaustive list of such elements or functions of the communications device, but only present an exemplary group of conventional elements.

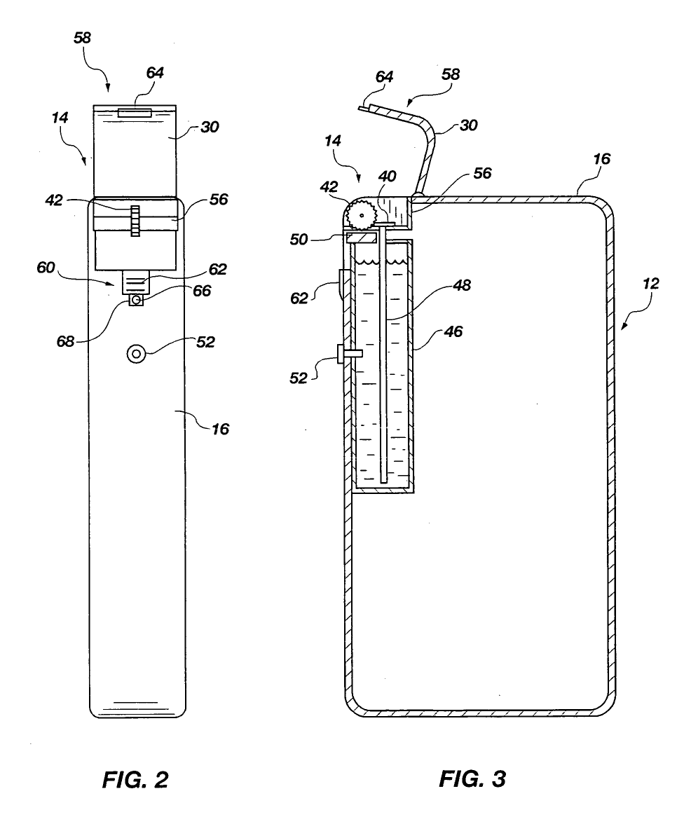

The ignition device 14, in a first embodiment depicted in FIGS. 1-3, comprises a gas-fueled system of the type conventionally known for butane lighters. Further, the embodiment of the invention depicted in FIGS. 1-3 is of a type having a friction element for igniting the fuel. Thus, referring to FIGS. 1 and 2, it can be seen that the housing 16 is structured with a safety mechanism in the form of a movable cover 30 which is generally structured in such a fashion that the cover 30 may be moved relative to the housing 16 to expose the heat source 34 of the ignition device 14. In but one exemplary configuration, the cover 30 is shown in FIG. 1 as being rotatable about a pivot pin 36. The cover 30 may also be configured to slide in a linear track or move in any other appropriate manner.

When the cover 30 is in the open position as shown, the opening 40 is exposed through which gas is expelled to form the flame, or heat source (not shown in FIGS. 1-3). Also, the rotating friction wheel 42 is positioned for access so that the user may rotate the friction wheel 42 to initiate the burning of the fuel as is well known and practiced with conventional butane lighters.

FIG. 3 depicts more clearly in cross section the ignition elements of the ignition device 12 of the first embodiment. A fuel reservoir 46 is housed within the housing 16 of the communications device 12. It should be noted that all other electronics and hardware associated with the communications device 12 are removed for ease of explanation, but are well known in the art and do not require explanation or depiction here. The fuel reservoir 46 is sized to be received in the housing 16 and to retain a selected amount of fuel, such as, for example, butane. The elements of a butane lighter are well-known in the art and only the principle elements are described herein.

A wick 48 is positioned within the fuel reservoir 46 and extends to the opening 40 to deliver fuel for igniting. Near the opening 40 is a rotatable friction wheel 42. The friction wheel 42 is also positioned in proximity to a flint 50 such that as the friction wheel 42 is spun, it interacts with the flint 50 to cause a spark which ignites the fuel emerging through the opening 40. The invention 10 may preferably include an adjustment member 54 (FIG. 1) which is operable to selectively regulate the fuel flow to the opening 40, as is well known in the art.

It should be noted that the ignition device 14 illustrated in FIGS. 2 and 3 is also of the type which is permanently secured within the housing 16, but is refillable through a valve 52 which emerges through the housing 16. It can also best be seen in FIGS. 2 and 3 that the invention is structured with a heat tolerant or heat resistant plate 56 which lies in proximity to the heat source (not shown in FIGS. 1-3), such as a flame. The heat plate 56 keeps the heat source (not shown in FIGS. 1-3) from overheating or igniting the housing or hardware of the communications device.

As previously noted, the mobile communications and ignitor device of the present invention is preferably structured with a safety mechanism that is selectively operable to prevent unintended ignition of the heat source (not shown in FIGS. 1-3), such as by a child or during certain times of use of the communications device. The safety mechanism may be structured or configured in any suitable manner that prevents ignition of the heat source and/or prevents access to the heat source during periods of unintended use. One exemplar safety mechanism 58 is shown in FIGS. 1-3 which comprises a movable cover 30 that encloses the heat source 32 and some of the ignition elements (e.g., friction wheel 42 or starter buttons described further herein).

The invention may preferably include a locking mechanism 60 that can be selectively enabled and disabled to enable or disable the safety mechanism 58 or another element contributing to the production of the heat source 32. Thus, for example, as best shown in FIG. 2, the locking mechanism 60 may comprise a latch mechanism further comprising a slidable button 62 positioned on the housing 16 which is structured to engage a tab 64 connected to the cover 30. Thus, when the cover 30 is in a closed position, the tab 64 is engaged by the button 62, and when the button 62 is slid in a direction away from the cover, the tab 64 is released thereby allowing for the opening of the cover 30. The cover may be manually openable or may be spring-loaded.

The locking mechanism may further be structured to lock in a secure fashion that requires an additional unlocking feature for security purposes. The additional security locking feature may be any type of mechanical and/or electrical device that provides an additional requirement for disabling the locking mechanism 60. In a most simplistic fashion, the additional security locking feature may, for example, comprise a depressible button 66 that is positioned within a recess 68 that the locking mechanism button 62 is slidably disposed in. Thus, in order to disable the locking mechanism 60 the depressible button 66 must be moved inwardly, such as by depression of a key 70 on the housing (FIG. 1), to allow the button 62 to slide within the recess 68.

Alternatively, the depressible button 66, or some other mechanically obstructive device which effectively enables the locking mechanism, may be activated to release or disable the locking mechanism by the input of a pre-programmed code using the keypad 20 of the communications device 12, or by a programmed voice command relayed through the microphone 24 of the communications device 12. Consequently, it would require a unique and unknown code to disable the security locking feature and access the ignitor device 14. It is preferred that if the security locking feature is operable by a pre-programmed code or voice command that the security locking feature also be provided with a manual override device that allows emergency use of the ignitor device 14 should the communications device become inoperable, thereby preventing use of the code or voice command to disable the locking feature.

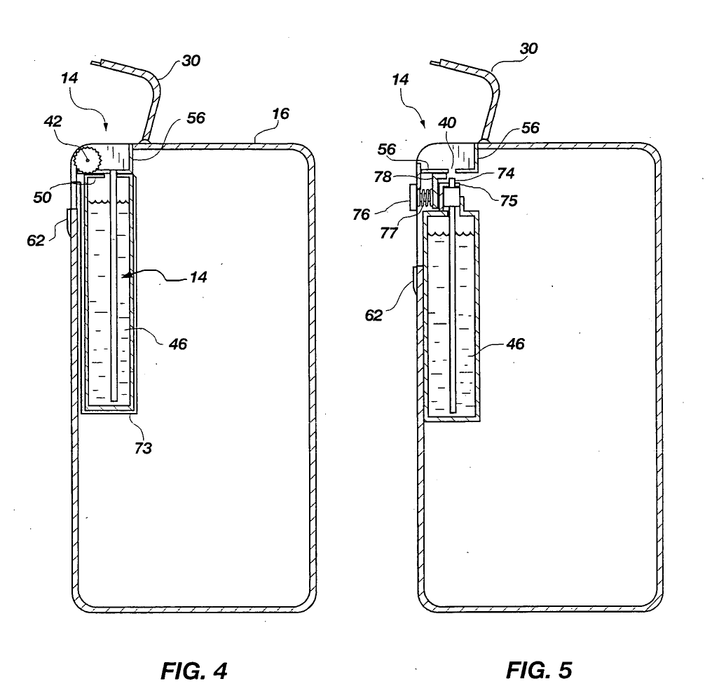

As previously noted, FIGS. 1-3 illustrate a first embodiment of the invention where the ignition elements of the ignitor device 14 are permanently housed within the housing 16. FIG. 4 illustrates a second alternative embodiment where the ignition elements of the ignitor device 14 are removable and replaceable with a new ignitor device 14. In such an embodiment, the safety mechanism, here shown as cover 30, is moved to a position away from the ignitor device 14 and the heat plate 56 is removed from the housing 16 to provide an enlarged opening in the housing 16 through which the ignitor device 14 can be removed. It can be seen that in this embodiment, the housing 16 may be especially formed with a chamber 73 particularly sized and shaped for receiving the ignitor device 14. It may be preferable to configure the chamber 73 in such a fashion that the replacement ignitor device 14 cannot be inserted incorrectly. It will be clear to one of skill in the art what ignition elements would removable and replaceable, but typically those ignition elements would include the fuel reservoir 46, friction wheel 42 and flint 50.

FIG. 5 illustrates a third alternative embodiment of the invention where the ignitor device 12 includes a fuel reservoir 46, but alternatively provides an electric sparking element for igniting the fumes from the fuel reservoir 46 near the opening 40. The electric sparking element may be structured in any suitable manner. FIG. 5 illustrates one well-known electric sparking element comprising a piezoelectric mechanism 77, which is depicted representationally.

In the embodiment shown in FIG. 5, the fuel reservoir 16 is further structured with a nozzle 74 that emits gas fumes. An actuation arm 75 is positioned in proximity to the nozzle 74 to release fumes from the nozzle 74. The actuation arm 75 is connected to a starter button 76 that is biased by a spring 77. A piezoelectric element 77 is positioned in proximity to the nozzle 74 and may be co-activated by the starter button 76. In known fashion, when the starter button 76 is depressed, the actuation arm 75 releases gas from the nozzle 74 and simultaneously the piezoelectric element 77 is struck in a manner that causes an electric spark to be produced in proximity to the emittance of the gas fumes, thereby producing a flame, or heat source, that emerges from the opening 40. As further illustrated in FIG. 5, the starter button 76 and opening 40 are positioned for enclosure by the safety mechanism or cover 30 for the reasons previously described.

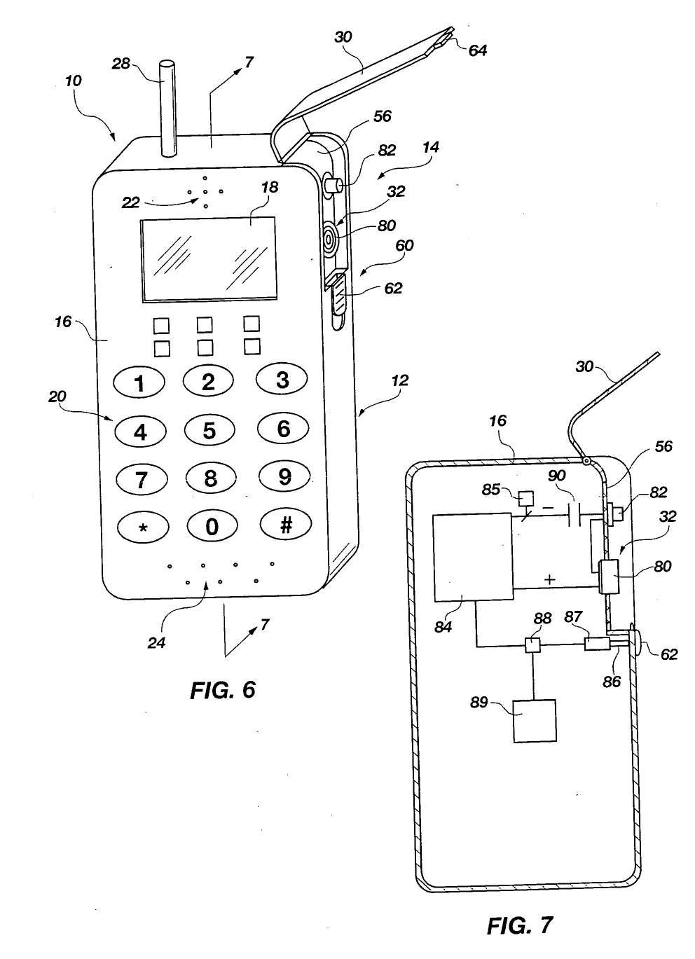

FIGS. 6 and 7 illustrate a fourth alternative embodiment of the invention where the heat source 32 is an electric heating element 80, similar to the type of heating element typically used in vehicles. In the embodiment illustrated in FIGS. 6 and 7, the heating element 80 may be heated by the continuous or momentary depression of an ignition button 82 that initiates a flow of electricity to the heating element 80. As more clearly shown in FIG. 7, the heating element 80 is electrically wired to a battery source 84 and is wired to the ignition button 82. The ignition button 82 is also wired to the battery source 84. Thus, when the ignition button 82 is depressed, a circuit is closed whereby electricity is provided to the heating element 80. The ignitor device 14 of this embodiment may preferably be structured in a suitable manner to open the circuit after an elapsed time to stop electricity from going to the heating element 80. In the simplest manner, this may be accomplished by releasing the ignition button 82 to open the circuit. Other electronic means well-known to those of skill in the art may be supplied to provide a similar assurance that the circuit will be opened to cease heating of the heating element 80, such as by an electronic timing element 85 shown schematically.

The embodiment of the device shown in FIG. 7 may also preferably be structured with a capacitor 90 having sufficient capacity to provide a charge to the heating element 80 such that if the communications device 14 should become inoperable (e.g., the battery becoming discharged), the ignitor device 14 may still be used in an emergency situation.

As with the other described embodiments, the embodiment illustrated in FIGS. 3, 6 and 7 includes a heat plate 56 that protects the housing 16 and internal structures of the communications device 12 from extreme heat. Also, as described with the prior embodiments, the alternative embodiment is provided with a safety mechanism 58, here shown as a cover 30, that shields the heat source 32 and prevents unintended ignition of the heating element 80. This safety mechanism 58 also includes a locking mechanism 60, here shown as a latching button 62 that engages a member 64 of the cover 30, as previously described.

FIG. 7 illustrates more clearly a security locking feature that may be employed with the locking mechanism 60 where a mechanical structure, such as a slidable pin 86 engages the latching button 62 to prevent it from being moved. The slidable pin 86 is associated with a solenoid 87 which is wired to a switch 88. The switch 88 is in turn wired to the battery source 84 and to a microprocessor 89. Thus, a pre-programmable code may be entered into the keypad 20 of the communications device 12 to cause the microprocessor 89 to activate the switch 88, which in turn provides flow of power from the battery source 84 to the solenoid 87 to move the pin 86 out of engagement with the latching button 62, thereby allowing the cover 30 to open and access be had to the heat source 32. When the cover 30 is closed again and secured by the latching button 62, the slidable pin 86 will mechanically engage the latching button 62 once again to prevent unintended or unauthorized access to the heat source 32. The same feature may be provided by a voice command as previously described. Again, it would be preferable to provide a manual override mechanism to allow the ignitor device 14 to be used in situations where the communications device 12 (e.g., battery or software failure) becomes inoperable.

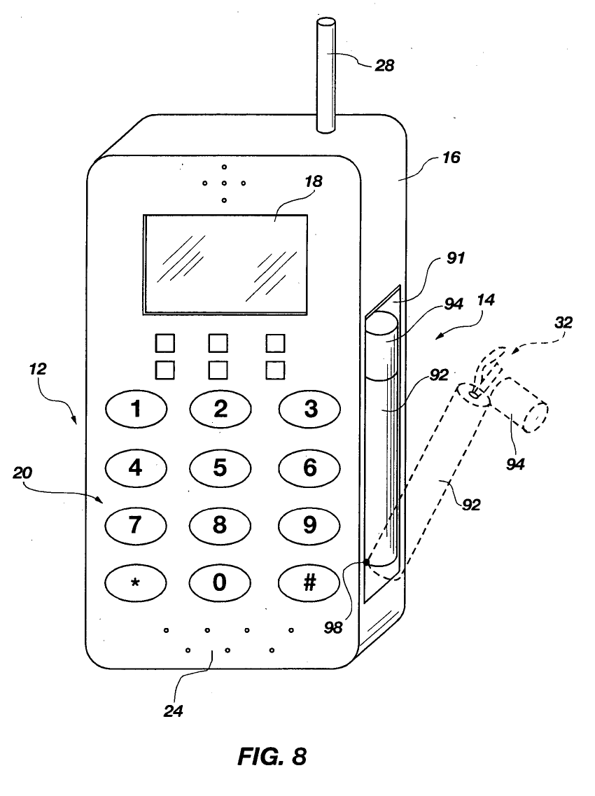

FIG. 8 illustrates a fifth embodiment of the invention where the ignitor device 14 is integrally formed as a part of the housing 16, but is not secured within the housing as described with the previous embodiments. That is, the ignitor device 14 may be a unit that is, for example, cradled within a channel 91 formed in the housing 16 of the device to position it an unobstructive placement relative to the communications device 12. The ignitor device 14 may be detachably attached to the housing 16 by any suitable means, such as a bracket (not shown) positioned within the channel 91 and sized to retain the ignitor device 14. Alternatively, the ignitor device 14 may be permanently attached to the housing 16, but otherwise accessible as necessary.

By way of example only, the ignitor device 14 is shown in FIG. 8 as being pivotally secured within the channel 91 so that the ignitor device 14 can be accessed more readily. Again, by example only, the ignitor device 14 may include a housing 92 that retains a fuel reservoir (not shown), and from which the heat source 32 (here shown as a flame) can be accessed. A moveable lid 94 may be made a part of the housing 92 to enclose the heat source 32. Thus, in use, the ignitor device 14 is rotated about pin 98 to release the ignitor device 14 from the channel 91 so that the device can be safely operated for providing a heat source 32.

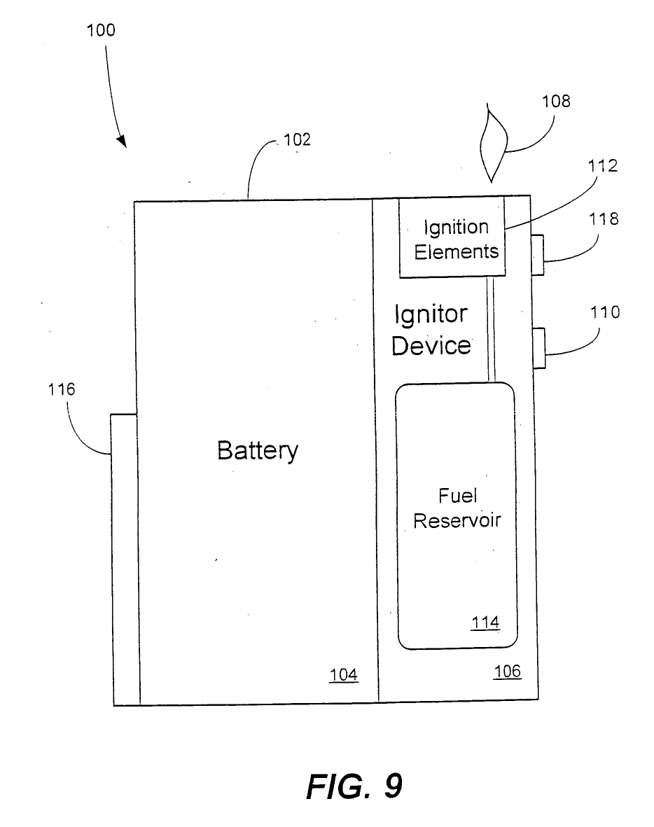

FIG. 9 is block diagram of an embodiment of a battery and ignitor device 100 according to the present invention. Device 100 may include a battery 104 configured for powering a mobile communications device (not shown). Device 100 may further include a housing 102 for enclosing the battery 104. Device 100 may further include an ignitor device 106 configured for attachment to housing 102 for providing a heat source 108 for ignition of flammable elements. Ignitor device 106 may be removably attached to housing 102, according to an embodiment of the present invention. Removable attachment of the ignitor device 106 from housing 102 may be facilitated by snaps, detents, spring-loaded mechanisms, clasps, hook and loop cloth, adhesive or any other suitable mechanical means for removably attaching the ignitor device 106 to housing 102. Ignitor device 106 may be enclosed within housing 102 according to another embodiment of the present invention. Housing 102 may further include a mechanical and electrical interface 116 configured for connection to the mobile communications device.

Device 100 may further include a safety mechanism 110 to prevent selective enablement of the heat source 108. The safety mechanism 110 may be a push button locking mechanism 110 (as shown in FIG. 9), or any other suitable mechanism configured for locking the ignitor device 106 thereby disabling ignition of the heat source 108 according to an embodiment of the present invention. Operational implementation of a push button locking mechanism 110 will be readily apparent to one of ordinary skill in the art and, thus, will not be further elaborated on herein. According to an alternative embodiment, safety mechanism 110 may be a movable cover associated with the housing for covering the heating element and a locking mechanism for selectively preventing movement of the cover. The safety mechanism 110 may be mechanically enabled and/or disabled according to an embodiment of the present invention.

Ignitor device 106 may include ignition elements 112 and a fuel reservoir 114 in communication with the ignition elements 112. Ignitor device 106 may further include a depressible switch for engaging the ignition elements 112 to generate the heat source 108. Fuel reservoir 114 may be refillable with fuel according to an embodiment of the present invention. The fuel may be a liquid flammable fuel that is not under pressure, such as lighter fluid or any other suitable flammable fuel that is not under pressure consistent with embodiments of the present invention. Alternatively, the fuel may be butane, propane or any other suitable compressible flammable gas according to other embodiments of the present invention. The ignition elements 112 may be removable and replaceable according to yet another embodiment of the present invention. The ignition elements 112 may include a friction wheel and flint according to an embodiment of the present invention.

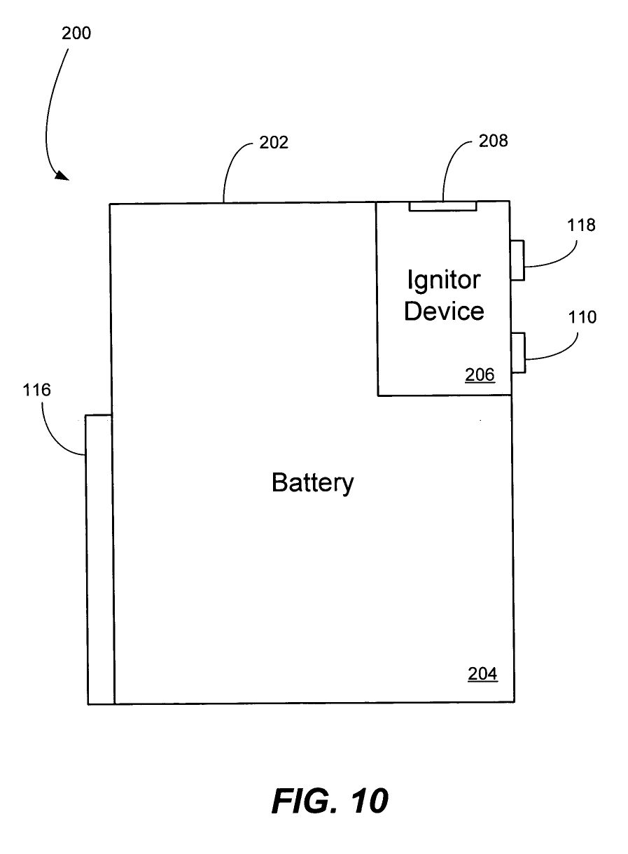

FIG. 10 is block diagram of an alternative embodiment of a battery and ignitor device 200 according to the present invention. Device 200 may include a housing 202 enclosing a battery 204 configured for powering a mobile communications device capable of contacting other persons or communication devices by wireless connections systems. Device 200 may include an ignitor device 206 within housing 202 or alternatively, removably attached to housing 202 and battery 204, according to embodiments of the present invention. Ignitor device 206 may be configured with a heat source including an electrical heating element 208. Ignitor device 206 may further be configured with a depressible switch 118 for initiating the electrical heating element 208. According to an embodiment of the present invention, ignitor device 206 may be configured with its own battery for powering electrical heating element 208. Alternatively, ignitor device 206 may be powered by battery 204 including any necessary electrical connections.

As noted above, features and methods of manufacturing a standalone electrically-based ignitor device are known in the art. For example, see U.S. Pat. No. 4,089,636 to Goto, U.S. Pat. Nos. 5,235,157, 5,274,214 and 5,285,050 all to Blackburn and U.S. Pat. No. 5,354,968 to Yamamura. Manufacturing methods for integrating ignitor devices 106, 206 with batteries 104, 204, respectively, consistent with the present invention will be within the knowledge of one of ordinary skill in the art without undue experimentation and, thus, will not be further elaborated on herein.

In still another embodiment of a battery and ignitor device 100, 200, an electronic receiver may be included and in communication with heating element 80 for receiving a wireless disable signal for disabling heating element 80. Such a wireless disable feature may be particularly useful in locations where it is desirable to disable the lighter function of the battery and ignitor device 100, 200, e.g., on an airplane or at a gasoline refueling station. The wireless disable signal may be generated by any suitable transmitter, broadcasting, e.g., at a preselected frequency, or according to any suitable wireless communications standard or technology (e.g., CDMA, TDMA, etc.) The implementation of such an electronic receiver for wirelessly disabling the ignitor device is within the knowledge of one of ordinary skill in the art and, thus, will not be further elaborated on herein.

The battery and ignitor devices 100, 200 described herein are particularly suitable as a third-party or after market replacement batteries for owners of conventional mobile phones, PDAs and any other mobile communications devices that are configured to be powered by a battery pack that mates with a mechanical and electrical interface 116 as described herein. Alternatively, battery and ignitor devices 100, 200 described herein are also suitable as component parts for manufacturers of conventional mobile phones, PDAs and any other mobile communications devices on an original equipment manufacturing (OEM) basis.

The mobile communications and ignitor device of the present invention is designed to provide a ready heat source for igniting flammable items, such as cigarettes or kindling, as previously described. The device of the present invention may be configured in any number of ways to provide a mobile communications device in conjunction with a safely usable ignitor device, and may include any number of other types of communications devices. For example, other features and embodiments of the mobile communications and ignitor devices may include waterproof, non-corrosive and/or rust-proof components. Thus, reference herein to details of the invention or the illustrated embodiments is by way of example only and not by way of limitation.

1. A battery and ignitor device, comprising:
a battery configured for powering a mobile communications device capable of contacting other persons or communications devices by wireless connections systems;
a housing enclosing the battery; and
an ignitor device configured for attachment to the housing for providing a heat source for ignition of flammable elements.

2. The battery and ignitor device according to claim 1, further comprising a safety mechanism to prevent selective enablement of the heat source.

3. The battery and ignitor device according to claim 2, wherein the safety mechanism comprises a push button locking mechanism configured for locking the ignitor device thereby disabling ignition of the heat source.

4. The battery and ignitor device according to claim 2, wherein the safety mechanism comprises a wireless receiver in communication with the heat source and configured for disabling ignition of the heat source upon receipt of a preselected wireless disable signal.

5. The battery and ignitor device according to claim 2, wherein the safety mechanism comprises a movable cover associated with the housing for covering the heating element and a locking mechanism for selectively preventing movement of the cover.

6. The battery and ignitor device according to claim 2, wherein the safety mechanism is mechanically enabled and disabled.

7. The battery and ignitor device according to claim 1, wherein the ignitor device is detachably connected to the housing.

8. The battery and ignitor device according to claim 1, wherein the ignitor device comprises ignition elements and a fuel reservoir in communication with the ignition elements.

9. The battery and ignitor device according to claim 8, wherein the fuel reservoir is refillable with fuel.

10. The battery and ignitor device according to claim 8, wherein the ignition elements are removable and replaceable.

11. The battery and ignitor device according to claim 8, wherein the ignition elements further comprise a friction wheel and flint.

12. The battery and ignitor device according to claim 8, wherein the ignition elements further comprise an electrical sparking member.

13. The battery and ignitor device according to claim 1, wherein the heat source comprises an electrical heating element.

14. The battery and ignitor device according to claim 13, wherein heating of the electrical heating element is initiated by a depressible switch.

15. The battery and ignitor device according to claim 1, further comprising a mechanical and electrical interface configured for connection to the mobile communications device.

16. The battery and ignitor device according to claim 1, further comprising a wireless receiver in communication with the battery and the ignitor device configured for receiving a wireless disable signal and thereafter disabling the ignitor device from igniting the heat source.
